(19) United States
(12) Patent Application Publication
(10) Pub. No.: US 2015/0172410 A1
(43) Pub. Date: Jun. 18, 2015

(54) CACHING WEB CONTENT USING MULTIPLE KEYS

(71) Applicant: eBay Inc., San Jose, CA (US)

(72) Inventors: Pascal Scoles, Collegeville, PA (US); Thomas Greco, Media, PA (US)

(21) Appl. No.: 14/133,539

(22) Filed: Dec. 18, 2013

(51) Int. Cl. H04L 29/08

(52) U.S. Cl. CPC H04L 67/2847

(57) ABSTRACT

Users of a web site may belong to different user groups, and receive content that applies to those user groups. Such content may be stored within a cache by a server system. In some cases, content may be stored in the cache based on a value that corresponds to all user groups to which a user belongs. Such an approach may be problematic in some instances, and result in increased cache misses. In an alternate approach, content is cached based on only one user group to which a user belongs, but may be cached under multiple keys in the event that a user belongs to numerous different user groups. By caching the content in multiple entries based on simpler keys, cache performance may be improved.

### TECHNICAL FIELD

The subject matter disclosed herein generally relates to data processing, and relates more particularly to caching web content using multiple keys.

### BACKGROUND

Caching data may increase the efficiency of data retrieval, particularly when the cached data is accessed multiple times. In the Internet environment, caching web content may therefore result in quicker response times (e.g., by a web server). This may especially be true in the case of web content that is generated (e.g., on the fly, as opposed to statically pre-determined web content), as generating web content may require the use of additional resources.

Web site users may also belong to a variety of different user groups. The particular groups to which a user belongs may change over time. For example, while a user may belong to a first set of particular groups at a first time, the user may belong to a second set of groups at a different time. Other users may belong to different sets of user groups. Thus, in a system with significant numbers of different user groups, the probability of any two users belonging to the exact same set of user groups may be low.

### BRIEF DESCRIPTION OF THE DRAWINGS

Some example embodiments are briefly described below, and are illustrated by way of example in the accompanying drawings. The scope of this disclosure, including the appended claims, is not limited to these examples.

FIG. 1A is a block diagram depicting a system that includes a server system and a client device, according to an example embodiment.

FIG. 1B is an interaction diagram illustrating information being exchanged between a client device and a server system, according to an example embodiment.

FIG. 2 is a diagram illustrating user groups to which a user may belong, and how those groups may change over time, according to an example embodiment.

FIG. 3 is a diagram showing various web content and user groups to which that content is applicable, according to an example embodiment.

FIG. 4A is a block diagram illustrating an example of a content request.

FIGS. 4B-4D are diagrams illustrating example embodiments of a cache in which web content is indexed based on a set of all user groups to which a user belongs.

FIGS. 5A-5B and FIGS. 6A-6B are diagrams illustrating example embodiments of caches in which web content is indexed based on a single user group.

FIG. 7 is a flow chart of an example embodiment of a method relating to caching web content.

FIG. 8 is a block diagram of an example embodiment of a computer-readable medium.

FIG. 9 is a block diagram of an example embodiment of a machine (e.g., computer system).

### DETAILED DESCRIPTION

In some instances, a cache may index web content according to a set of all user groups to which a user belongs (e.g., a cache entry may have a tag that corresponds to a hash value of all groups for a user). In such a case, cache misses may be a significant problem. (As will be understood by one of skill in the art, a cache miss occurs when an attempt to locate data in a cache is made, but the attempt fails, while a cache hit occurs when then attempt succeeds.)

If web content is cached with a tag that is based on a first set of particular user groups, for example, it may only be locatable in the cache using that specific combination of groups. If the set of user groups to which a user belongs changes, the web content may no longer be accessible, causing a miss in the cache. Also, if a second user does not belong to the exact set of user groups under which web content was originally cached, this scenario may also result in a cache miss-even if the second user is a member of some (but not all) of a set of user groups under which the web content was originally cached.

Thus, in a system in which user groups may change, caching web content with a single entry having a tag based on a specific set of user groups may result in many cache misses, slowing operations.

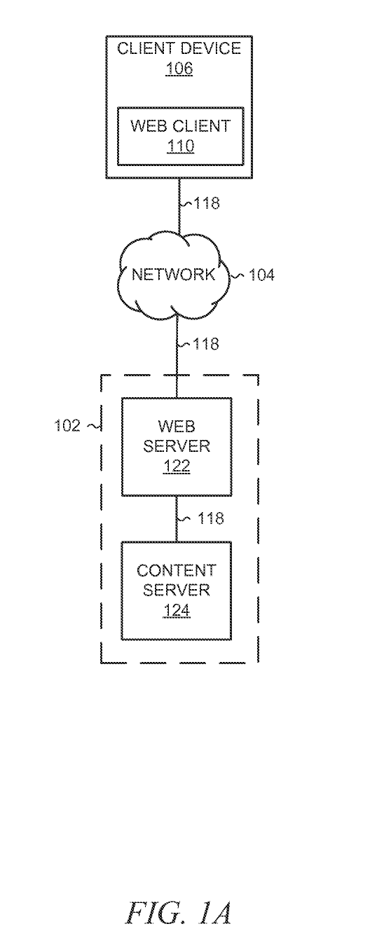

FIG. 1A is a block diagram depicting a system that includes a server system 102 and a client device 106. As shown, server system 102 is linked to client device 106 via network connections 118 and a network 104. Additional devices, servers, networks, network connections, databases, or other data or communication-related structures may be present in various other embodiments in the system of FIG. 1A, as would occur to one with skill in the art.

In the embodiment of FIG. 1A, client device 106 includes a web client 110. Web client 110 may be browsing software such as Mozilla® Firefox™ Google® Chrome™, Microsoft® Internet Explorer™, or another program configured to request or receive web content, in various embodiments.

Client device 106 may be any of a variety of different device types. For example, client device 106 may be a laptop or desktop computer system, or may be a mobile device such as a smartphone (e.g., iPhone™ device, Android™ device) Consistent with some embodiments, client device 106 may alternatively be a tablet computer, such as an iPad™, a set-top box (STB) such as provided by cable or satellite content providers, a video game system console such as the Nintendo® Wii™, the Microsoft® Xbox 360™, or the Sony® PlayStation™ 3, or other any number of other suitable computing devices.

Consistent with some example embodiments, client device 106 may include any appropriate combination of hardware or software, and have one or more processors capable of reading and executing instructions stored on a non-transitory machine-readable medium. Client device 106 may interface via one or more connections 118 with a communication network 104 (e.g., the Internet, a Wide Area Network (WAN), Local Area Network (LAN)). Depending on the form of client device 106, any of a variety of types of connections 118 and communication networks 104 may be used. Communication network 104 may therefore include a cellular network or other wireless network in various example embodiments.

In the example embodiment shown, server system 102 includes a web server 122 and a content server 124. Web server 122 is configured, in one example embodiment, to receive a content request from client device 106 and return web content to client device 106 in response to the request. Content server 124, in some example embodiments, is configured to generate web content to be included in a response to client device 106. In other instances, however, content server 124 may provide pre-existing web content. Thus web server 122 may communicate with content server 124 to acquire web content to be transmitted to client device 106 in some scenarios. In some example embodiments, server system 102 may only include web server 122 or content server 124, while in other example embodiments, web server 122 and content server 124 may be suitably combined as a single system. Thus, server system 102 includes one or more different computer systems, in various example embodiments.

Note that as used herein, the term “web content” broadly refers to any video, text, images, script, code, executable programs, or other digital data that can be transmitted via a network (such as the Internet). Web content may relate to advertising, product data (pricing, sizing, availability, product options), discounts, offers, or coupons, for example, but is not limited to such. Thus, the term “content”, also used herein, may refer to web content.

Turning to FIG. 1B, an interaction diagram is shown of one example embodiment in which information is exchanged between a client device 156 and a server system 162. Aspects of this chart will also be discussed in greater detail below relative to other figures.

In the example embodiment of FIG. 1B, a user belonging to at least two different user groups requests content from server system 162. Subsequently, as described below, two different cache entries that link specific web content to the two different user groups are stored, which allows the linked web content to be accessed via the two different cache entries.

Note that as used herein, the term “linking,” as it relates to the relationship of first web content to a first user group in a cache entry, indicates that there are references to both (or copies of) the first web content and the first user group, and that there is an association between the first web content and the first user group (for example, the first web content is applicable to the first user group, as explained below).

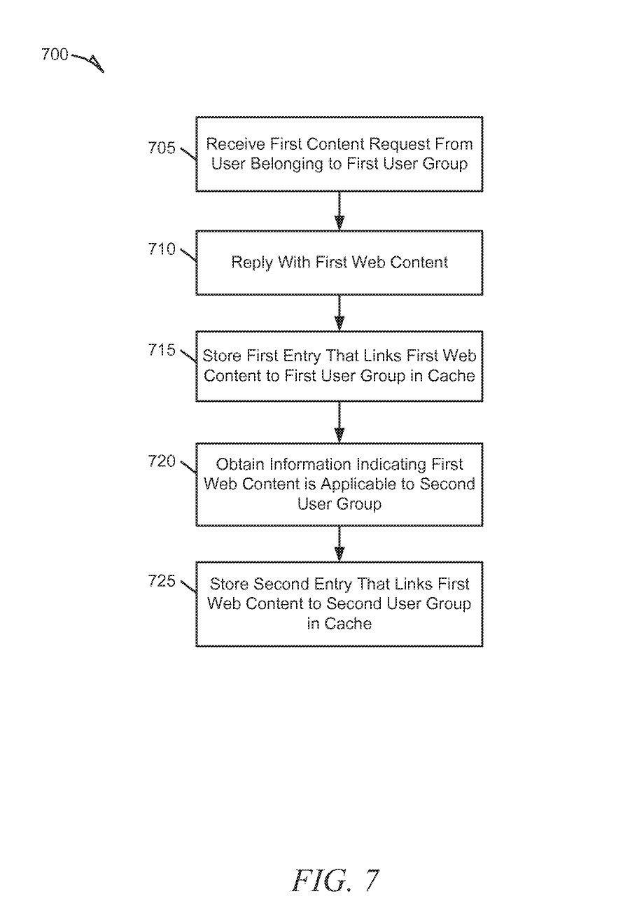

FIG. 1B is intended to provide an overview level of detail, and accordingly, some of the operations (or portions thereof) shown in FIG. 1B are discussed in greater depth relative to other example embodiments (such as method 700 discussed relative to FIG. 7.) Note that in the example embodiment shown, client device 156 may include any or all features, characteristics, of client device 106 in various example embodiments. Likewise, server system 162 may include any or all features, characteristics, or structures of server system 102. Accordingly, server system 162 may include a web server, content server, or other computer systems in various example embodiments.

As shown in FIG. 1B, in operation 172, a first content request is sent by a user of client device 156 to server system 162. In some example embodiments, the first content request is a request for a web page (e.g., a hypertext transfer protocol (HTTP) request for a particular uniform resource identifier (URI)). In operation 174, server system 162 may then determine a first user group to which the user of client device 156 belongs. After this determination, first web content is sent to client device 156 in operation 176. Prior to transmission in operation 176, the first web content may be generated or retrieved from another data source.

Subsequently, server system 162 may determine (in operation 178) a second user group to which the user of client device 156 also belongs. First and second cache entries are then stored by server system 162 in operation 180. The first cache entry links the first web content to the first user group, while the second cache entry links the first web content to the second user group. In the example embodiment of FIG. 1B, both of these cache entries are independently usable to later access the cached first web content.

At a later time, in operation 181, the user of client device 156 leaves the first user group. The user leaving the first user group may occur in response to a variety of different actions (e.g., by the user, or others). After the user leaves the first user group in the example embodiment of FIG. 1B, however, the user still remains in the second user group. In operation 182, a second content request is then sent to server system 162 (by the same user of device 156, who is no longer in the first user group, but is still in the second user group).

Subsequently, in operation 184, server system 162 obtains the first web content via the second cache entry, and delivers it to client device 156 in operation 186. Note that in this example, because the user of client device 156 is no longer in the first user group, that user can easily access the second cache entry, allowing the same cached web content to be provided to the user again, despite the user's changing group memberships. This concept will also be further discussed below.

Note that in this example, the first cache entry is not accessible in response to the second content request because the user no longer belongs to the first user group. However, the second cache entry is accessible, and because the second entry links the first web content, that web content can be retrieved from cache without having to take extra operations that would involve re-generating the first web content. Aspects of the above overview will be discussed in greater detail below relative to various example embodiments.

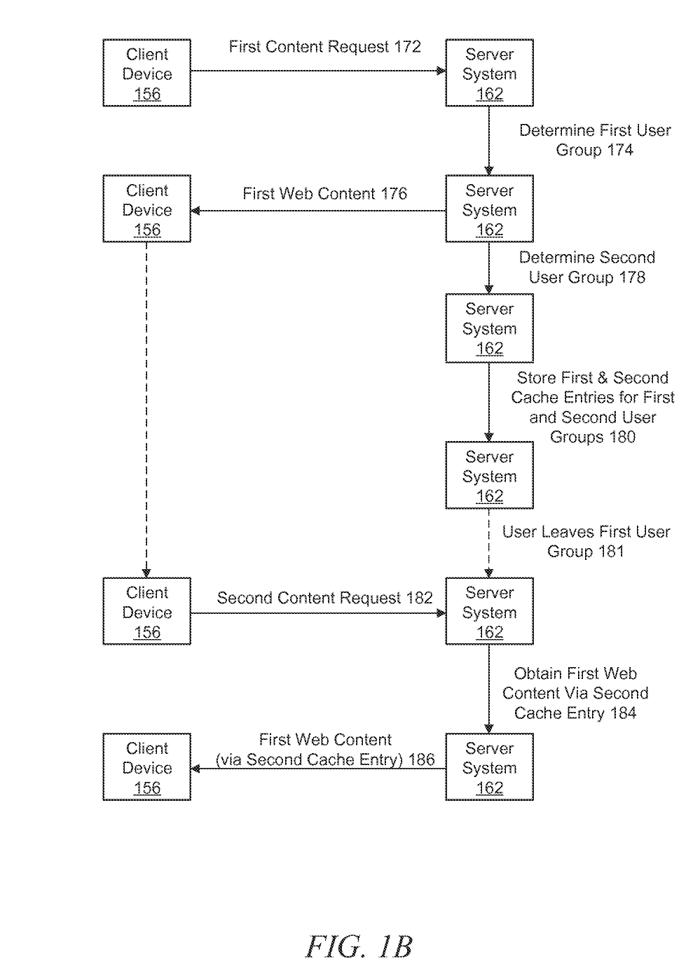

Turning to FIG. 2, a diagram 200 is shown that illustrates the user groups to which a user may belong, and how those groups may change over time. As explained further below, a variety of factors may determine to what groups a user belongs.

In general, different user groups may have different membership criteria. That is, membership of a first group may be determined by one or more first factors, while membership of a second group is determined by one or more second factors (one or more of which may be different from the first factors).

A web site may therefore have different user groups that represent different segments of that web site's user base (e.g., segmented by age group, gender, or other criteria, as discussed further below). A first user group may have some overlap in membership with another user group (users in common), or may have no overlap at all (no users in common), depending on how the user groups are set up, or depending on one or more of various factors (e.g., criteria).

For example, users may therefore be segmented into one or more different groups on one or more of any of the following criteria (e.g., subject to any relevant restrictions, such as privacy restrictions):
1. Whether a user is currently “logged in” to a web site (e.g., actively browsing);
2. Demographic information for a user, such as age, gender, race, income level, educational background;
3. Location information, such as zip code, city, state, country, county, prefecture, street address; and
4. Browsing history, such as actions taken by a user relative to one or more websites (including navigation actions such as particular pages that have been visited or particular web content that has been viewed, a length of time the user has spent viewing a particular page or web content, a history of items previously ordered by a user, a history of other transactions by a user).
   Numerous other criteria relating to information about users or actions taken by users are usable to define user group memberships in various example embodiments. Thus, generally speaking, any information concerning a user or a computing device associated with a user may be used to classify that user as belonging to one or more specific user groups. In other words, user groups are not limited to being determined based on criteria from the examples given above.

In some example embodiments, all users of a web site are classified as belonging to one common user group. In other words, in some cases, at least one user group for a web site will include every single user of that web site. This user group may or may not be explicitly defined. That is, in some example embodiments, a common user group to which all users belong may be implicitly defined as part of a web site's programming scheme, while in other example embodiments, the common user group to which all users belong is set up and defined like other user groups, except it does not have any specific criteria for membership (e.g., other than the mere existence of the user). This concept is further discussed below.

In the example embodiment of FIG. 2, at a first time t₀, a first user of a web site belongs to a first set of user groups 205. Set 205 includes only Group 0 (labeled as the “universal group” in this example). This universal group represents the set of all users of the web site—that is, it has no explicit criteria for membership. All users of the web site belong to the “universal group”, including the first user. (Note that in other example embodiments, however, no universal group exists.) Thus, at time t₀, the first user belongs to no groups other than the universal group. Time t₀ may therefore correspond to the first time that the first user has used the web site, in one example.

Note that as shown, user groups are identified by number, with Group 0 being the universal group. In other example embodiments, different schemes may be used to identify user groups (e.g., alphanumeric string, binary code, or some combination thereof). In some example embodiments, different identification schemes for groups may also co-exist. Each user group will therefore have its own corresponding unique identifier in a variety of scenarios.

At time t₁, the first user of the web site has changed group memberships and now belongs to a set of groups 210. Set 210 includes user groups 1, 3, and 12 (emphasis added to show changes), and also includes the universal group 0. Note that in this example embodiment, the first user will always belong to group 0. The first user may belong to groups 1, 3, and 12 by virtue of group membership criteria defined for those user groups (e.g., user's age, whether the user is logged in, user browsing or ordering history).

At a later time t₂, one or more events has caused a change in the groups to which the first user belongs (now shown as a different set 215). Thus, between time t₀ and t₁, the first has been removed from group 12 and added to group 9 (emphasis shown in figure). At a further time t₂, the first user has been removed from groups 3 and 9, and added to group 7, and now belongs to set of user groups 215. At a still further time t₄, the first user has been removed from all groups other than universal group 0.

As will be explained further below, the user groups to which a user belongs may affect how web content is cached (for that user, as well as other users). In some example embodiments, for example, a cache entry may be created for each user group to which a user belongs. Thus, web content may be cached under multiple different keys corresponding to user group identifiers, in some example embodiments

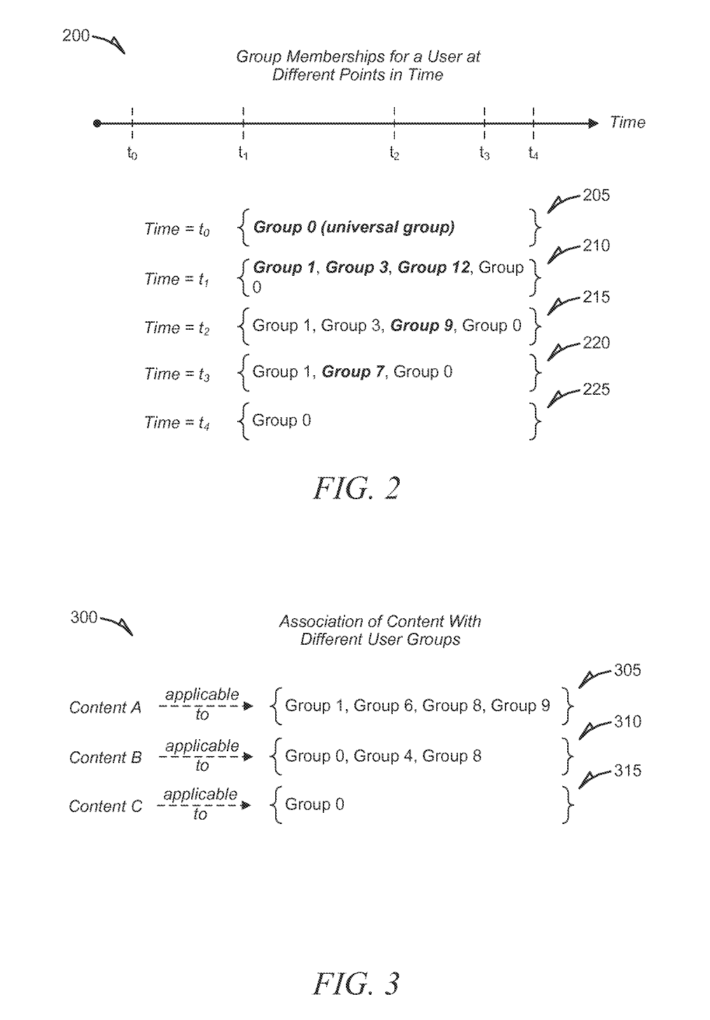

Turning to FIG. 3, a block diagram 300 is shown depicting various particular web content and user groups to which the particular web content applies. As explained below, web content associated with a web site may be applicable to any number of users groups to which one or more users may belong. Note that as used herein, the term “applicable to,” as it relates to the relationship between first web content and a first user group, indicates that the first web content is presentable to users within the first user group (i.e., users may request or receive that web content from server system 102).

As just one example of how web content may apply to different groups, an advertising campaign might target male boating enthusiasts between the ages of 25 and 49. In this example, one or more pieces of advertising content (e.g., “Content A” shown in FIG. 3) are associated with user groups respectively defined by the following criteria:
Group 1: {all male users}
Group 6: {all users between age 25 and 49}
Group 8: {all users who own boats}
Group 9: {all users who have visited one or more boating-related websites in the last 30 days}
   Accordingly, FIG. 3 shows content A as applying to a set of user groups 305. Note that generally, any suitable schema or data structure may be used to store information indicating a relationship (applicability) between particular web content and one or more user groups, such as a data base.

In this example, the user groups to which a piece of advertising content (content A) applies are based on one or more rules defined by an authorized user of a web site (e.g., a website to which a content request is directed). An advertising entity, administrator of a website, or other authorized user or entity, may explicitly define one or more rules, for example, that indicate whether specific web content applies to one or more particular user groups. In one example embodiment, an authorized user specifies criteria that is used by server system 102 to determine whether web content applies to one or more user groups. As discussed above, the criterion “all male users” may be one criterion. Thus, in some example embodiments, if particular web content is applicable to a particular user group, that web content may be presented to various users that belong to that user group.

Continuing the example above, the different groups to which content A applies may have overlap in their membership. For example, a user who is age 30, of unknown gender, owns a boat, and has visited a boating-related website in the last 30 days would belong to groups 6, 8, and 9. These user groups would therefore have at least one member in common. In practice, particularly on larger websites, some user groups may have a great deal of overlap in membership. Also, note that while an advertising campaign was used in the example above, many different possible bases may exist for specifying that particular content applies to one or more user groups.

Thus, a variety of different rules or criteria may be used to determine who belongs in particular user groups. User groups may also be determined, in some example embodiments, on a partially speculative basis. That is, a system may not have definitive information indicating user fits a particular criterion, but may make an assumption (e.g., using a default value) regarding that criterion based on one or more factors. User group membership may be based on self-reported data (e.g., to a particular web site) as well as data collected about a user from one or more other sources (e.g., data gathered from other web sites or other channels) User group changes may be based on particular navigation actions (e.g., within a web browser) or other factors, as discussed herein relative to various example embodiments.

In the example embodiment of FIG. 3, content B is shown as applying to a different set of user groups 310, including group 0 (the “universal” user group in this example, group 4, and group 8. Thus, content B may also apply to a same user group to which content A also applies (group 8). Lastly, content C is shown as applying to only universal user group 0. Thus, any particular web content may apply to one or more user groups, including or excluding a universal user group, in varying example embodiments. Note that the while the universal group is depicted as “group 0” in this example, it may be identified differently in one or more example embodiments.

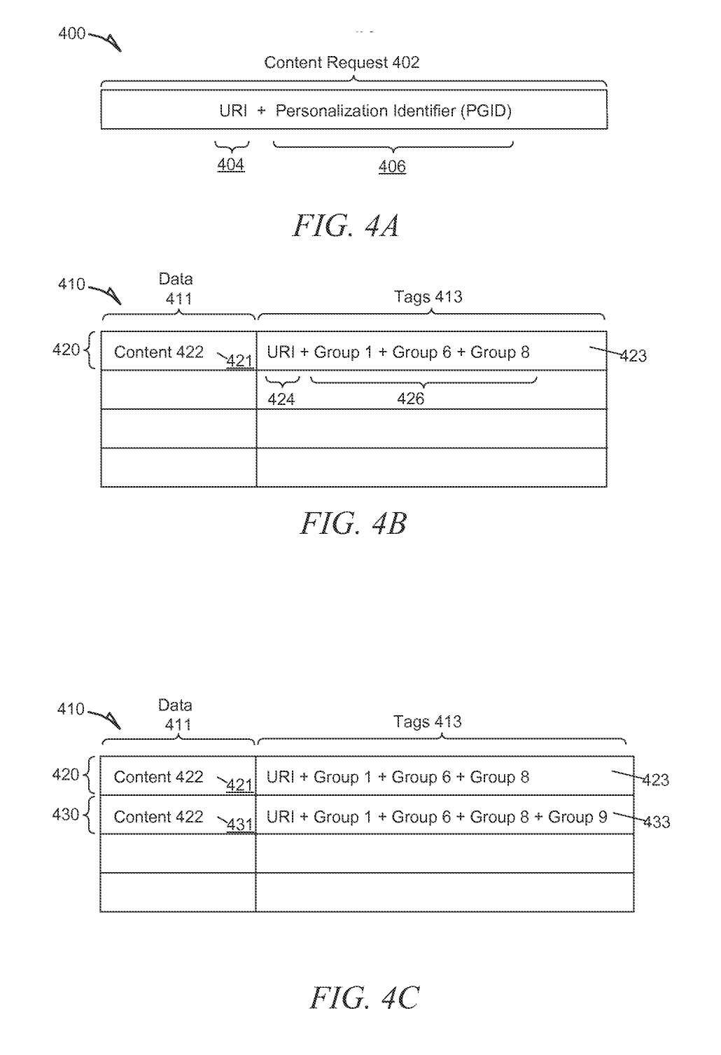

Turning to FIG. 4A, a block diagram 400 is shown illustrating one example embodiment of a request for content. For example, content request 402 may be transmitted from a client device (such as device 106 or 156) and received by a server system (e.g., server system 102 or 162) in various example embodiments. In one example embodiment, content request 402 may take the form of an HTTP request.

As depicted, content request 402 includes a requested uniform resource identifier (URI) 404. URI 404 may identify a particular web page, for example. In some example embodiments, URI 404 may identify only a portion of a web page, or other web content that is accessible via a communications network. Thus, in some example embodiments, a content request may include another type of network resource identifier (e.g., other than a URI.)

In the example embodiment of FIG. 4A, content request 402 also includes a personalization identifier (PGID) 406. In the example embodiment shown, personalization identifier 406 serves as an identifier corresponding to a user who is making content request 402. In some instances, personalization identifier 406 includes an identifier that specifies the set all user groups to which a particular user belongs. personalization identifier 406 may also include an identifier that does not directly specify user groups (e.g., by identifiers for one or more user groups), but is otherwise usable to determine one or more user groups to which the particular user belongs. For example, personalization identifier 406 may include a unique identifier that is usable by a server system to look up additional information (e.g., from a database) and determine a set of all user groups to which a particular user belongs. (In one example embodiment, personalization identifier 406 is therefore a globally unique identifier for a user.) In some cases, personalization identifier 406 may be stored as a cookie file that is transmitted to or read by a server system. In accordance with the above, personalization identifier 406 may therefore identify a user or be usable to determine one or more user groups (e.g., all user groups) to which the user belongs.

In some example embodiments, content request 402 includes URI 404 but does not include personalization identifier 406 (i.e., there is no personalization identifier field). In such example embodiments, a user making content request 402 may be assumed by server system 102 to belong to a “universal” user group to which all users belong, in some example embodiments. Thus, even if there is insufficient identifying information to determine a unique identity for a user at the time a content request is made, the user may be assumed to be in the universal user group (described as “group 0” relative to various example embodiments above, for example). By assuming membership exists in a universal user group, for example, certain cached web content may be accessed by server system 102 in response to user requests from unidentified users in one example embodiment.

FIGS. 4B-4D relate to a web content cache that is accessible based in part on the identity (e.g., user group memberships) of a particular user associated with a content request (such as request 402). Generally, a cache used relative to any embodiment herein may be stored on web server 122, content server 124, or some other system that is part of server system 102.

Thus, turning to FIG. 4B, a block diagram is shown of one example embodiment of a cache 410. In this example embodiment, cache 410 is generally configured to store data 411 and tags 413. Cache 410 also includes a single cache entry 420. Tags 413 are generally usable as lookup keys for one or more items of respectively corresponding data 411, for example.

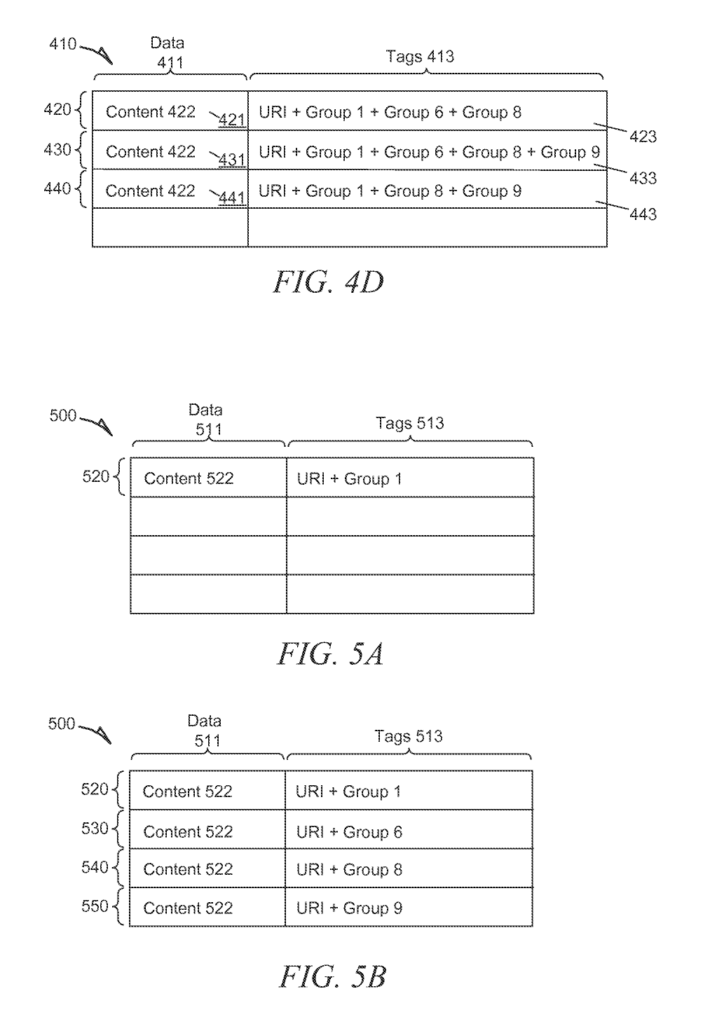

As shown, tags 413 are generated based on identifiers that include all user groups to which a user belongs (e.g., a user associated with content request 402). As discussed below, this approach may cause cache segmentation, and lead to inefficient cache operation due to cache misses. An alternate approach will be illustrated further below with respect to FIGS. 5A-5C.

As shown, cache entry 420 includes a data portion 421 that stores web content 422. Cache entry 420 also includes a tag portion 423 that includes a URI 424 and an identifier 426. URI 424 corresponds to a URI associated with web content 422 (e.g., a web page on which web content 422 appears). Identifier 426 corresponds to all user groups to which a particular user belongs at a time that a content request is made by the particular user. In FIG. 4B, web content 422 has therefore been stored in cache 410 in association with a first user who belonged to user groups 1, 6, and 8 (as indicated by identifier 426). As the groups to which the first user belongs change over time, however, cache entry 420 may no longer be immediately accessible.

Thus, in FIG. 4C, a block diagram is shown of cache 410 at a later time. At this time, cache 410 includes an additional entry 430, corresponding to an additional content request.

Entry 430 corresponds to a content request for the same URI and same web content 422 as in entry 420, but the requesting user in this example belongs to a different set of user groups, as seen in tag 433. For example, the requesting user corresponding to entry 430 may be the very same user as the earlier requesting user corresponding to cache entry 420, but the user now belongs to an additional user group 9. Thus, due to the user groups being different, a cache miss for entry 420 may occur in this example, causing the creation of entry 430 (despite having overlap between the user groups). Accordingly, in this example, any change in the user groups to which a user belongs may cause a cache miss, even for the same web content and same URI, as the tag portion would have changed. Entry 430 therefore stores an identical copy of web content 422 in data portion 431, but is indexed with different tag portion 433.

Turning to FIG. 4D, a block diagram is shown of cache 410 at a still later time with an additional cache entry 440 having a data portion 441 and a tag portion 443. In this example, entry 440 again corresponds to the same web content 422 and URI as in entries 420 and 430, but includes a different tag portion. For example, a requesting user may have again changed user groups (e.g., leaving group 6, but remaining in groups 1, 8, and 9), thus resulting in a cache miss for entries 420 and 430 and the creation of new cache entry 440.

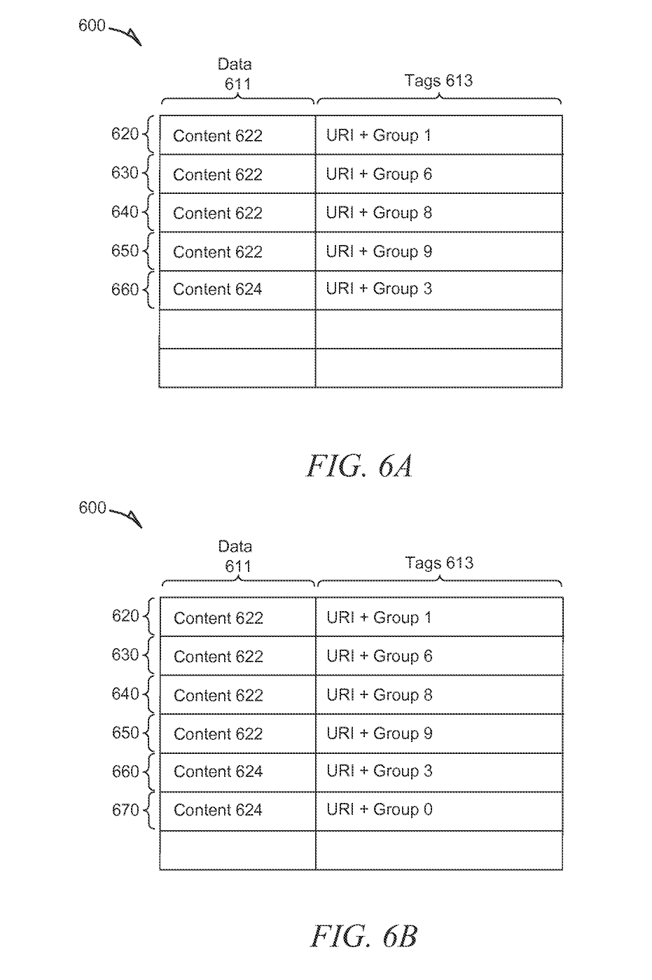

Accordingly, in the example embodiment of FIGS. 4B-4D, changing user group memberships (even for a same user) may result in cache fragmentation and cache misses, as existing cache entries cannot be located due to cache tags being based on (e.g. generated based on) a combination of all user groups to which a user belongs. In scenarios in which a user changes groups frequently, the approach of FIGS. 4B-4D can have a serious impact on cache performance. As illustrated below relative to example embodiments shown in FIGS. 5A-5B and FIGS. 6A-6B, however, alternative approaches to cache storage may cause reduced cache misses as a result of caching web content in a different manner.

Turning to FIG. 5A, a block diagram is shown of one example embodiment of a cache 500. In this example embodiment, cache 500 is configured to store cache entries including data 511 and corresponding tags 513. As described below, entries for cache 500 are indexed differently from the cache entries described above relative to FIGS. 4B-4D. More specifically, in the example embodiment shown, each entry in cache 500 is indexed based on a corresponding single user group (rather than all user groups to which a user belongs), which may decrease cache misses.

As shown, entry 520 includes web content 522. In some example embodiments, web content 522 is a complete copy of specific web content (which may have been generated in response to a user request). In other example embodiments, web content 522 (as stored within cache entry 520) may be only a partial copy of web content or may include a link (e.g., a URI) to web content. Thus, in various example embodiments, a cache entry that “links web content with a user group” may include all, a portion of, or even none of the specific web content for that entry (in which case a link or other means may be provided to access the specific web content).

Entry 520 further includes a tag portion that includes a URI and an identifier for user group 1. Thus, in the example embodiment shown, entry 520 is indexed with a key that is based on only one user group.

Turning to FIG. 5B, a block diagram is shown of cache 500 at a later time. In this figure, additional cache entries 530, 540, and 550 have been added to cache 500. Each of entries 530, 540, and 550 have respective data portions that also store web content 522, but have different tag portions. The tag portions for entries 530, 540, and 550 are likewise based on a same URI, but each are also based on a respective different user group. In the example of FIG. 5B, the current state of cache 500 may be a result of a request from a user belonging to groups 1, 6, 8, and 9, with the request being for web content 522 from the URI shown (although this is not the only possible scenario that could result in the current state of cache 500).

In other words, in the example embodiment of FIGS. 5A-5B, a single requesting user may cause multiple cache entries to be created (e.g., by server system 102), with each cache entry corresponding to one of a set of one or more user groups to which the requesting user belongs. Web content 522 may therefore be accessed (e.g., by server system 102) based on only a single one of user group 1, 6, 8, and 9 (in contrast to the example embodiment of FIGS. 4B-4D). Therefore, a user who belongs to any one of groups 1, 6, 8, or 9 and requests the URI may cause a cache hit, rather than a cache miss, to occur.

Turning to FIGS. 6A and 6B, block diagrams are shown of a cache 600 at different points in time. Similar to FIGS. 5A-5B, the cache shown in FIGS. 6A-6B is configured to index data (e.g., web content) with tags that are based on a single user group to which a user belongs, rather than all user groups to which a user belongs.

In FIG. 6A, cache 600 is configured to store data 611 and tags 613 for various entries. As shown, cache 600 includes entries 620, 630, 640, 650, and 660. Entries 620-650 each correspond to a same URI and store the same web content 622, but are indexed based on different user groups in their corresponding tag portions. Entry 660 is an entry that stores web content 624 for the same URI, but stores a user group 3 that is different from the user groups shown in the tag portions of the other entries. Thus, in some example embodiments, a given URI may be associated with different web content in a cache. For example, two different portions of a web page may include different web content that is stored separately.

In FIG. 6B, cache 600 is shown at a later time with an additional entry 670. Entry 670 also stores web content 624, like entry 660, but has a different tag portion based on the same URI and a different user group 0. In this example, group 0 is a “universal” user group to which all users belong. Accordingly, because entry 670 is based on the universal user group, any user requesting web content 624 in association with that URI should result in a cache hit by server system 102.

Thus, in some example embodiments in which web content is indexed in cache 600 under a universal user group, that web content is guaranteed to cause at most only one cache miss (e.g., the first time the web content is loaded into the cache), and should result in only cache hits from thereon (e.g., until and unless the relevant cache entry is flushed from the cache). As indicated by entries 660 and 670, web content may also be cached based on a universal user group (group 0 in this example), as well as cached based on one or more specific groups (e.g., group 3). Cache replacement and cache flushing may be handled as needed by various techniques, in various example embodiments.

Turning to FIG. 7, a flow chart of one example embodiment of a method 700 is shown. One or more operations of method 700 may be performed by a server system (e.g., server system 102) in various example embodiments. In some example embodiments, one or more operations of method 700 may be omitted, while in other example embodiments, one or more additional operations may be performed. Portions of method 700 may be performed consistent with the disclosure above. For example, the cache referred to in method 700 may be configured like cache 500 or cache 600. Portions of method 700 may also be performed in an order different than the order shown, in some example embodiments.

In operation 705, a first content request is received from a first user who belongs to a first user group. In this example, the first user also belongs to one or more additional user groups, as discussed below. The received content request may be content request 402, for example, and may include a requested URI or personalization identifier (personal identifier) for the first user. In operation 710, a reply with first web content is transmitted (e.g., from server system 102 to a client device).

In operation 715, a first entry is stored in a cache. The first entry links the first web content to the first user group. For example, referring back to FIG. 6A, entry 620 links web content 622 to user group 1. The first entry in the cache may include a complete copy of the first web content, for example, or may include a URI or other network location for the first web content, in some example embodiments.

Operation 715 may also include, in one example embodiment, checking the cache to see if a pre-existing entry is already present. Thus, if an entry that links web content 622 to user group 1 is already present, a duplicative entry is not stored in some example embodiments. Further, in the event that particular web content is indicated as applying to a universal user group (to which all users belong), the cache may be searched for that particular web content using an identifier for the universal user group.

In operation 720, information is obtained that indicates the first web content is applicable to a second user group. The obtained information may correspond to the information shown in FIG. 3, in one example embodiment. For example, server system 102 may obtain information indicating that the first web content is applicable to a number of one or more different user groups (e.g., the information in FIG. 3 indicating that “content A” is applicable to user groups 1, 6, 8, and 9). Accordingly, in some example embodiments, operation 720 may include determining two or more user groups to which the first web content applies. In one example embodiment, all or a portion of operation 720 may be performed after operation 705 and prior to operation 710.

In operation 725, a second entry is stored in a cache (e.g., the same cache in which the first entry from operation 715 is stored). The second entry links the first web content to the second user group (to which the first web content also applies). Thus, after operation 725 is performed, at least two entries for the first web content may exist in the cache: the first entry (e.g., linking the first user group) and the second entry (e.g., linking the second user group). In some scenarios, one or more additional cache entries may also be stored linking the first web content to one or more additional user groups to which the first web content applies. For example, web content that is applicable to four user groups (e.g., content A from FIG. 3) would result in the creation of four different cache entries (e.g., assuming no relevant pre-existing entries already existed).

Additional example embodiments of method 700 are discussed further below. In these additional example embodiments, operations may be performed by server system 102, for example.

In one further example embodiment of method 700, a second content request is received from a second user who belongs to the second user group. In this example, the second content request either specifies the first web content (or specifies other web content that includes the first web content). After determining an identifier for the second user group, the second cache entry (which was stored in operation 725) is located based on the identifier for the second user group. The first web content is then obtained via the second entry in the cache (e.g., as part of a cache hit). Obtaining first web content via the cache includes, in example embodiments, reading a complete copy of the first web content as stored in the cache, or reading information (such as a network or file location) from the cache that is usable to locate the first web content and then accessing the web content at that location. The second content request is then replied to with the first web content that was obtained via the cache.

In another example embodiment of method 700, the first web content is generated in response to the first content request. For example, content server 124 may dynamically generate the first web content (e.g., as opposed to simply obtaining a piece of static pre-determined web content). Thus, in some cases, web content that is stored in a cache and linked to user groups may have been initially generated in response to a first request, but is not generated a second time when a cache hit results, which may conserve server resources.

In yet another example embodiment of method 700, the first content request is processed asynchronously from storing the first and second entries in the cache, and a reply is transmitted in response to the first content request prior to completion of storing the first and second entries in the cache. For example, in this example embodiment, a server system may begin transmitting a reply to the first content request asynchronously with respect to cache operations, in order to increase response time (as opposed to forcing the first user to wait for the first web content until cache operations were completed). In other words, processing the first content request asynchronously means that the reply transmitted to a user device does not depend upon a result of the cache storage operations, in an example embodiment.

Another example embodiment of method 700 includes determining that the first user belongs to the first user group based on one or more actions of the first user taken relative to a website. Thus, in various example embodiments, as also discussed above, a user may belong to different user groups based on a number of actions taken by the user, such as navigating to particular web pages, ordering particular items, or submitting identifying information (e.g., demographic information). Method 700 may also include determining that the first user belongs to the first user group based on an identifier included in the first content request. For example, a personalization identifier (such as PGID 406) may indicate a set of all user groups to which the first user belongs.

In another example embodiment of method 700, a server system (such as 102, 162, or other suitable system) may also determine that the first web content is applicable to the second user group based on the first user belonging to the second user group. Thus, in one example embodiment, one or more additional groups to which the first user belongs would have entries stored in the cache linking those groups with the first web content. For example, all user groups to which the first user belongs could have corresponding cache entries created. In other example embodiments, however, cache entries are created based only on what user groups particular web content applies to, and not user groups to which a (first) requesting user belongs.

Method 700 may also include replying to the first content request with additional web content other than the first web content. For example, a web page may include numerous web content items, only one of which is the first web content. Note that in some instances, static web content (e.g., portions of a web page that are not personalized or otherwise related to the particular user groups to which users may belong) is not cached in a cache such as cache 500 or cache 600, which may be reserved only for specific web content that depends on user group membership.

In yet another example embodiment of method 700, a second content request is received from the first user. In this example, the second content requests also corresponds to the first web content, but the user no longer belongs to the first user group (which is linked to the first web content in the first cache entry). Accordingly, the first cache entry may not be usable to locate the first web content. However, after determining that the user belongs to the second user group, the first web content is obtained via the second cache entry (rather than the first cache entry, for example). A reply to the second content request is then transmitted, the reply including the first web content that was obtained via the second cache entry.

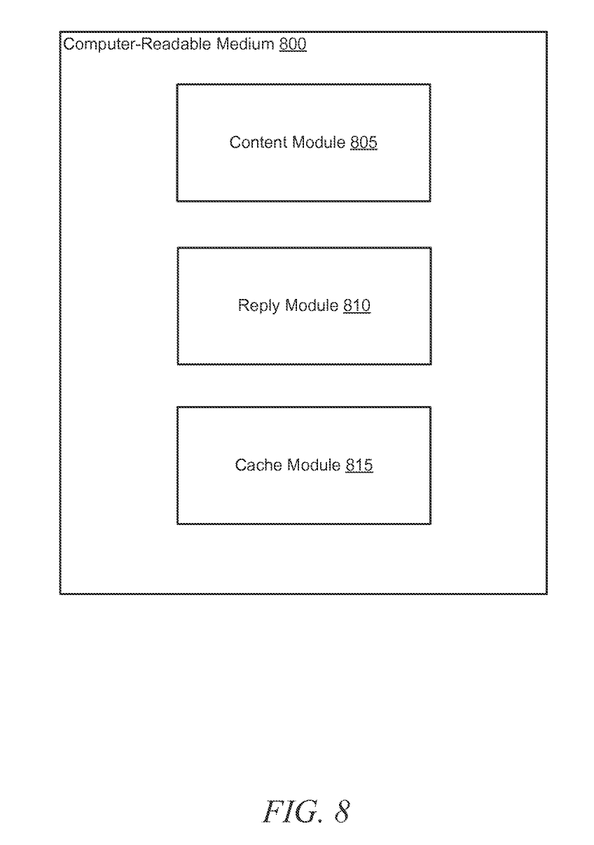

Turning to FIG. 8, a block diagram illustrating one example embodiment of a non-transitory computer-readable medium 800 is shown. Computer-readable medium 800 includes a content module 805, a reply module 810, and a cache module 815. These modules may each include computer-executable instructions that may cause a suitable system (e.g., server system 102 or server system 162) to perform particular operations. As shown, content module 805 is configured to obtain first web content based on a first content request from a first user. The first web content may be obtained by communicating with content server 124 or another suitable system, or by accessing local storage. Obtaining the first web content may also include generating the first web content, in some instances.

Reply module 810 is configured to cause the first web content to be transmitted to a user computing device associated with the first user (e.g., client device 106). In one example embodiment, reply module 810 is configured to cause the first web content to be transmitted asynchronously from cache operations (e.g., storing cache entries in a cache, as described below relative to cache module 815), which may reduce delay and enhance user experiences, in some instances.

Cache module 815 is configured to perform various operations, including storing, in a cache (e.g., cache 500 or cache 600) a first entry that links the first web content to the first user group. Cache module 815 is also configured to store a second entry in the cache based on information indicating that the first web content is (also) applicable to a second user group. The second cache entry links the first web content to the second user group, and thus, a user belonging to either the first or second user group may be able to access the first web content via the cache.

Additional modules may also be stored on computer-readable medium 800. For example, in one example embodiment, a content generation module is configured to generate the first web content based on the first content request. Generating the first web content may be performed as described above in example embodiments.

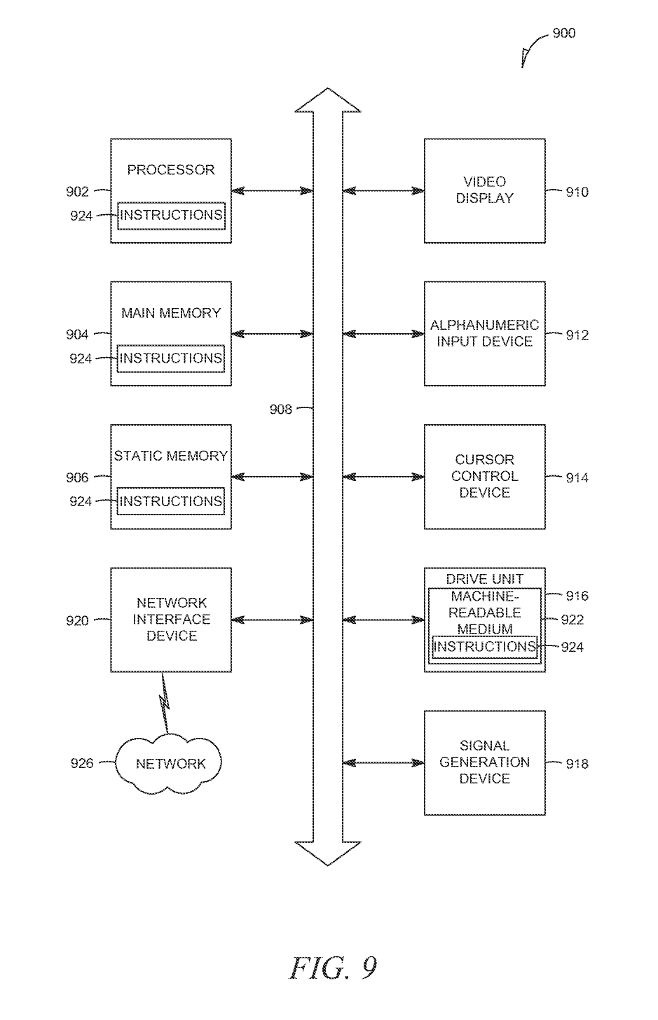

Turning to FIG. 9, a block diagram illustrating components of a machine 900 is shown. Machine 900 may be used to implement client device 106, server system 102, web server 122, content server 124, or other computing systems consistent with some example embodiments.

Machine 900, according to some example embodiments, is able to read instructions 924 from a machine-readable medium 922 (e.g., a computer-readable storage medium) and perform any one or more of the methodologies discussed herein, in whole or in part. Specifically, FIG. 9 shows machine 900 in the example form of a computer system within which instructions 924 (e.g., software, a program, an application, an applet, an app, other executable code) for causing machine 900 to perform any one or more of the methodologies discussed herein may be executed, in whole or in part. In alternative example embodiments, machine 900 operates as a standalone device or may be connected (e.g., networked) to other machines. In a networked deployment, machine 900 may operate in the capacity of a server machine or a client machine in a server-client network environment, or as a peer machine in a distributed (e.g., peer-to-peer) network environment. Machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein.

Machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. Processor 902 may contain microcircuits that are configurable, temporarily or permanently, by some or all of instructions 924 such that the processor 902 is configurable to perform any one or more of the methodologies described herein, in whole or in part. For example, a set of one or more microcircuits of processor 902 may be configurable to execute one or more modules (e.g., software modules) described herein.

Machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). Machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

Storage unit 916 includes machine-readable medium 922 (e.g., a tangible and non-transitory machine-readable storage medium, such as computer-readable medium 800) on which are stored the instructions 924 embodying any one or more of the methodologies or functions described herein. Instructions 924 may also reside, completely or at least partially, within the main memory 904, within processor 902 (e.g., within the processor's cache memory), or both, before or during execution thereof by machine 900. Accordingly, main memory 904 and processor 902 may be considered machine-readable media (e.g., tangible and non-transitory machine-readable media). Instructions 924 may be transmitted or received over the network 190 via the network interface device 920. For example, network interface device 920 may communicate the instructions 924 using any one or more transfer protocols (e.g., hypertext transfer protocol (HTTP)).

In some example embodiments, machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by machine 900, such that the instructions 924, when executed by one or more processors of machine 900 (e.g., processor 902), cause machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain example embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
receiving a first content request from a first user who belongs to a first user group;
replying to the first content request with first web content;
storing, in a cache, a first entry that links the first web content with the first user group;
obtaining information indicating that the first web content is applicable to a second user group; and
based on the obtained information, a processor of a computer system causing a second entry that links the first web content with the second user group to be stored in the cache.

2. The method of claim 1, further comprising:
receiving a second content request from a second user who belongs to the second user group;
determining an identifier for the second user group;
based upon the identifier for the second user group, locating the second entry in the cache;
obtaining the first web content via the second entry in the cache; and
replying to the second content request with the obtained first web content.

3. The method of claim 1, further comprising:
generating the first web content in response to the first content request; and
wherein the first and second entries in the cache each include a copy of the first web content.

4. The method of claim 1, further comprising:
processing the first content request asynchronously from storing the first and second entries in the cache; and
transmitting a reply to the first content request prior to completion of storing the first and second entries in the cache, the transmitted reply including the first web content.

5. The method of claim 1, wherein the first content request is a request for a web page.

6. The method of claim 1, further comprising determining that the first user belongs to the first user group based on one or more actions of the first user taken relative to a website.

7. The method of claim 1, further comprising determining that the first user belongs to the first user group based on an identifier included in the first content request, wherein the identifier indicates a set of all user groups to which the first user belongs.

8. The method of claim 1, further comprising determining that the first web content is applicable to the second user group based on the first user belonging to the second user group.

9. The method of claim 1, further comprising determining that the first web content is applicable to a plurality of user groups that include the second user group, based on one or more rules specified by an authorized user of a web site to which the first request is directed.

10. The method of claim 1, wherein replying to the first content request includes replying with other web content in addition to the first web content.

11. The method of claim 1 further comprising:
receiving a second content request from the first user
determining the first user belongs to a second user group and no longer belongs to the first user group, the second user group having an identifier;
based upon the identifier, obtaining the first web content via the second entry in the cache; and
replying to the second content request with the obtained first web content.

12. An article of manufacture comprising a non-transitory computer-readable medium having stored thereon instructions that, when executed by one or more processors of a computer system, cause the computer system to perform operations comprising:
receiving a first content request from a first user;
determining a first user group to which the first user belongs;
generating first web content for the first user based on the first user group;
causing the first web content to be transmitted to a user computing device associated with the first user,
storing, in a cache, a first entry that links the first web content to the first user group;
obtaining information indicating that the first web content is applicable to second and third user groups; and
based on the obtained information:
storing a second entry in the cache that links the first web content with the second user group; and
storing a third entry in the cache that links the first web content with the third user group.

13. The article of manufacture of claim 12, wherein the operations further comprise:
receiving a second content request from the first user;
determining the first user belongs to the second user group;
obtaining the first web content via the second entry in the cache; and
replying to the second content request with the obtained first web content.

14. The article of manufacture of claim 13, wherein the operations further comprise determining that the first user no longer belongs to the first user group.

15. The article of manufacture of claim 12, wherein determining the first user group to which the first user belongs is based on an identifier included in the first content request, wherein the identifier indicates a set of all user groups to which the first user belongs.

16. The article of manufacture of claim 12, wherein each entry in the cache is indexed using a corresponding tag that includes a uniform resource identifier (URI) and an identifier for a user group.

17. A system, comprising:
one or more processors; and
a non-transitory computer-readable medium having stored thereon:
a content module that is configured, when executed by the one or more processors, to obtain first web content based on a first content request from a first user, the first web content being applicable to a first user group to which the first user belongs;
a reply module that is configured, when executed by the one or more processors, to cause the first web content to be transmitted to a user computing device associated with the first user; and
a cache module that is configured, when executed by the one or more processors, to:
store, in a cache, a first entry that links the first web content with the first user group; and
based on information indicating that the first web content is applicable to a second user group, store, in the cache, a second entry that links the first web content with the second user group.

18. The system of claim 17, wherein the reply module is configured, when executed by the one or more processors, to cause the first web content to be transmitted asynchronously from the cache module storing the first and second entries in the cache.

19. The system of claim 17, wherein the non-transitory computer-readable medium has stored thereon:
a content generation module configured, when executed by the one or more processors, to generate the first web content based on the first content request.

20. The system of claim 17, wherein the cache module is configured, when executed by the one or more processors, to store a complete copy of the first web content in each of the first and second entries in the cache.
